(19) United States
(12) Patent Application Publication
(10) Pub. No.: US 2003/0128802 A1
(43) Pub. Date: Jul. 10, 2003

(54) Resist material and exposure method

(76) Inventor: Nobuyuki Matsuzawa, Kanagawa (JP)

Correspondence Address: Robert J. Depke, Holland & Knight LLC, Suite 800, 55 West Monroe Street, Chicago, IL, 60603-5144, US

(21) Appl. No.: 10/308,357

(22) Filed: Dec. 3, 2002

(30) Foreign Application Priority Data
Dec. 20, 2001 (JP) P2001-388417

(51) Int. Cl. G21K 5/00

(52) U.S. Cl. 378/34

(57) ABSTRACT

An exposure method comprising subjecting a resist layer to selective exposure to an X-ray and forming a predetermined pattern in the resist layer, wherein the resist layer comprises a polymer material having an oxygen atom content nₒ of less than 0.05 in terms of the atomic ratio of an oxygen atom to all atoms contained in said polymer material, and having a density ρ which satisfies at least one formula selected from the group consisting of the following formulae (1) and (2):

$$\begin{matrix}ρ \leq \frac{\begin{matrix}3.66 \times ( 12.011 \times ( 1 - {n}_{o} ) / 2 + \\ 15.9994 \times {n}_{o} + 1.00794 \times ( 1 - {n}_{o} ) / 2 )\end{matrix}}{32.4297 \times ( 1 - {n}_{o} ) / 2 + 126.595 \times {n}_{o} + 1.3607 \times ( 1 - {n}_{o} ) / 2} \times 1.25 & ( 1 ) \\ ρ \leq \frac{\begin{matrix}3.66 \times ( 12.011 \times ( 1 - {n}_{o} ) / 3 + 15.9994 \times {n}_{o} + \\ 1.00794 \times ( 1 - {n}_{o} ) \times 2 / 3 )\end{matrix}}{\begin{matrix}32.4297 \times ( 1 - {n}_{o} ) / 3 + 126.595 \times \\ {n}_{o} + 1.3607 \times ( 1 - {n}_{o} ) \times 2 / 3\end{matrix}} \times 1.25 & ( 2 )\end{matrix}$$

By using a specific polymer material in a resist material, the absorption in the wavelength range of an extreme ultraviolet (EUV) light of the resist material can be reduced while securing favorable etching resistance, thus enabling a more improved ultra-fine processing than before.

### CROSS REFERENCE TO RELATED APPLICATIONS

The present document is based on Japanese Priority Document JP2001-388417, filed in the Japanese Patent Office on Dec. 20, 2001, the entire contents of which being incorporated herein by reference.

### BACKGROUND OF THE INVENTION

1. Field of the Invention

The present invention relates to a resist material and an exposure method which are used in microfabrication in, for example, the field of semiconductor.

2. Description of Related Art

In, for example, the field of semiconductor, as the degree of integration of semiconductor devices is increasing, an urgent task is to establish a new processing technique which enables processing of an ultra-fine pattern as small as, for example, 0.1 μm or less.

A so-called lithography technique is indispensable to processing of a fine pattern. For improving the optical resolution in the lithography technique by using a light for exposure having a shorter wavelength to apply the lithography technique to ultra-fine processing, vigorous studies are being made not only on the improvement of the conventional exposure technique using an ultraviolet light from a mercury lamp or a KrF (krypton-fluorine; wavelength: 248 nm) or ArF (argon-fluorine; wavelength: 193 nm) excimer laser but also on the development of a new exposure technique using an extreme ultraviolet (hereinafter, frequently referred to simply as “EUV”) light having a wavelength of around 7 to 16 nm.

However, a general resist conventionally used in the lithography has a problem in that it exhibits high optical absorption in the wavelength range of an EUV light, and thus the light radiated does not reach the bottom portion of the resist layer, so that a favorable rectangular resist pattern cannot be formed, causing deterioration of the resist pattern. Since the deterioration of the resist pattern makes it considerably difficult to facilitate ultra-fine processing, the method of avoiding the resist pattern deterioration has been desired.

In order to solve the problem of the resist pattern deterioration, a method has conventionally been employed in which thickness of a resist film is reduced to about 150 nm or less to improve collective transmittance of the resist layer. However this method poses a problem in that the resist layer cannot exhibit satisfactory etching resistance due to its small thickness of the resist film.

### SUMMARY OF THE INVENTION

In view of the above conventional problems, the present invention provides a resist material using a specific polymer material which exhibits smaller absorption advantageously in the wavelength range of an EUV light while ensuring favorable etching resistance. In addition, the present invention also provides an exposure method which lowers the absorption in the wavelength range of an EUV light of a resist layer and enables a more improved ultra-fine processing than before.

In an aspect of the present invention, there is provided a resist material comprising a polymer material having an oxygen atom content nₒ of less than 0.05 in terms of the atomic ratio of an oxygen atom to all atoms contained in the polymer material, and having a density ρ which satisfies at least one formula selected from the group consisting of the following formulae (1) and (2):

$$\begin{matrix}ρ \leq \frac{\begin{matrix}3.66 \times ( 12.011 \times ( 1 - {n}_{o} ) / 2 + \\ 15.9994 \times {n}_{o} + 1.00794 \times ( 1 - {n}_{o} ) / 2 )\end{matrix}}{32.4297 \times ( 1 - {n}_{o} ) / 2 + 126.595 \times {n}_{o} + 1.3607 \times ( 1 - {n}_{o} ) / 2} \times 1.25 & ( 1 ) \\ ρ \leq \frac{\begin{matrix}3.66 \times ( 12.011 \times ( 1 - {n}_{o} ) / 3 + 15.9994 \times {n}_{o} + \\ 1.00794 \times ( 1 - {n}_{o} ) \times 2 / 3 )\end{matrix}}{\begin{matrix}32.4297 \times ( 1 - {n}_{o} ) / 3 + 126.595 \times \\ {n}_{o} + 1.3607 \times ( 1 - {n}_{o} ) \times 2 / 3\end{matrix}} \times 1.25 & ( 2 )\end{matrix}$$

In addition, in another aspect of the present invention, there is provided an exposure method comprising a step of subjecting a resist layer to selective exposure to an X-ray and forming a predetermined pattern in the resist layer, wherein the resist layer comprises a polymer material having an oxygen atom content nₒ of less than 0.05 in terms of the atomic ratio of an oxygen atom to all atoms contained in the polymer material, and having a density ρ which satisfies at least one formula selected from the group consisting of the above formulae (1) and (2).

Generally, for exhibiting resist properties, it is necessary that the polymer material constituting a resist layer contain an oxygen atom. In the polymer material, the moiety that is capable of undergoing a certain chemical reaction due to light irradiation and making a difference in the values of physical properties between the irradiated portion and the unirradiated portion to cause the polymer material to exhibit resist properties is a group necessarily containing an oxygen atom, such as an ester group, a phenolic hydroxyl group, an alcoholic hydroxyl group, and a carboxyl group.

However, in the wavelength range of an EUV light, the optical absorption of oxygen is higher than that of carbon or hydrogen, and therefore the oxygen contained in the polymer material causes the light transmittance of the polymer material to be lowered. The optical absorption of per one atom of an oxygen atom is as very high as about 3 times that of a carbon atom, and about 50 to 100 times that of a hydrogen atom.

In the present invention, the resist material or the resist layer comprises a polymer material which meets the above-mentioned requirements. In other words, in the polymer material, the atomic ratio of an oxygen atom to all atoms constituting the polymer material is relatively small, and hence the collective optical absorption of the polymer material can be lowered. For this reason, even when the resist layer has a thickness as large as 200 nm or more, the resist layer can achieve a transmittance as high as 40% or more, which is enough for exhibiting its resist properties.

The larger the oxygen atom content nₒ of the molecules in the resist material, the poorer the etching resistance of the molecules in the resist material. However, in the present invention, a polymer material having a value nₒ of less than 0.05 is used in the resist material wherein the value nₒ is determined by dividing the number of oxygen atoms contained in the polymer material by the number of all atoms contained in the polymer material. Therefore, the resist material of the present invention can achieve more favorable etching resistance than that of a resist material using a novolak resin (oxygen atom content no: 0.056) which is known to have a favorable etching resistance.

In the present invention, a polymer material which meets the predetermined requirements is used in the resist layer. Therefore, even when the resist layer has a thickness as large as 200 nm or more, a favorable resist pattern can be obtained in the resist layer. In addition, a process exhibiting favorable etching resistance can be achieved, thus enabling a more improved ultra-fine processing than before.

### BRIEF DESCRIPTION OF THE DRAWING

FIG. 1 is a graph showing the relationship between an oxygen atom content nₒ and a density ρ with respect to a polymer material.

### DESCRIPTION OF THE PREFERRED EMBODIMENT

Hereinbelow, an exposure method of the present invention will be described in detail with reference to the accompanying drawing.

The exposure method of the present invention may be applied to, for example, ultra-fine pattern processing for semiconductor devices. Specifically, the exposure method comprises the steps of: applying a photosensitive resist material onto a substrate to form a resist layer; subjecting the resist layer to selective exposure to an X-ray; and developing the resultant resist layer to form a predetermined pattern in the resist layer.

As the X-ray for exposure, an X-ray having an arbitrary wavelength can be used, but, especially when an extreme ultraviolet (EUV) light having a specific wavelength (wavelength: 7 to 16 nm)(i.e., soft X-ray) is used in the exposure, the resolution obtained is higher than that has been obtained ever before.

The exposure for the resist layer is conducted by, for example, reduction projection utilizing a reduction projection optical system.

A polymer material used in the resist layer comprises, as a main skeleton, for example, at least one resin selected from the group consisting of a novolak resin, a polyhydroxystyrene resin, an acrylic resin, a siloxane resin, a silsesquioxane resin, and a polycycloolefin resin.

The polymer material comprising the above-mentioned resins used in a resist frequently contains an aromatic ring, such as a benzene ring. This is because a resist material containing an aromatic ring has more favorable etching resistance.

In the resin as a main skeleton, the moiety that is capable of undergoing a certain chemical reaction due to light irradiation and making a difference in the values of physical properties between an irradiated portion and an unirradiated portion to cause the resin to exhibit resist properties is a group containing an oxygen atom, such as an ester group, a phenolic hydroxyl group, an alcoholic hydroxyl group, and a carboxyl group.

In the wavelength range of an EUV light, the intensity of the optical absorption of an element descends in the following order: F>O>C>Si>H. In other words, a polymer material containing an oxygen atom is disadvantageous from the viewpoint of reduction in the optical absorption in the wavelength range of an EUV light.

In the present invention, for lowering the absorption in the wavelength range of an EUV light of the polymer material used in the resist material, as the polymer material, there is used a polymer material having a value (oxygen atom content) no of less than 0.05 wherein the value nₒ is determined by dividing the number of oxygen atoms contained in the polymer material by the number of all atoms contained in the polymer material, and having a density ρ which satisfies at least one formula selected from the group consisting of the following formulae (1) and (2):

$$\begin{matrix}ρ \leq \frac{\begin{matrix}3.66 \times ( 12.011 \times ( 1 - {n}_{o} ) / 2 + \\ 15.9994 \times {n}_{o} + 1.00794 \times ( 1 - {n}_{o} ) / 2 )\end{matrix}}{32.4297 \times ( 1 - {n}_{o} ) / 2 + 126.595 \times {n}_{o} + 1.3607 \times ( 1 - {n}_{o} ) / 2} \times 1.25 & ( 1 ) \\ ρ \leq \frac{\begin{matrix}3.66 \times ( 12.011 \times ( 1 - {n}_{o} ) / 3 + 15.9994 \times {n}_{o} + \\ 1.00794 \times ( 1 - {n}_{o} ) \times 2 / 3 )\end{matrix}}{\begin{matrix}32.4297 \times ( 1 - {n}_{o} ) / 3 + 126.595 \times \\ {n}_{o} + 1.3607 \times ( 1 - {n}_{o} ) \times 2 / 3\end{matrix}} \times 1.25 & ( 2 )\end{matrix}$$

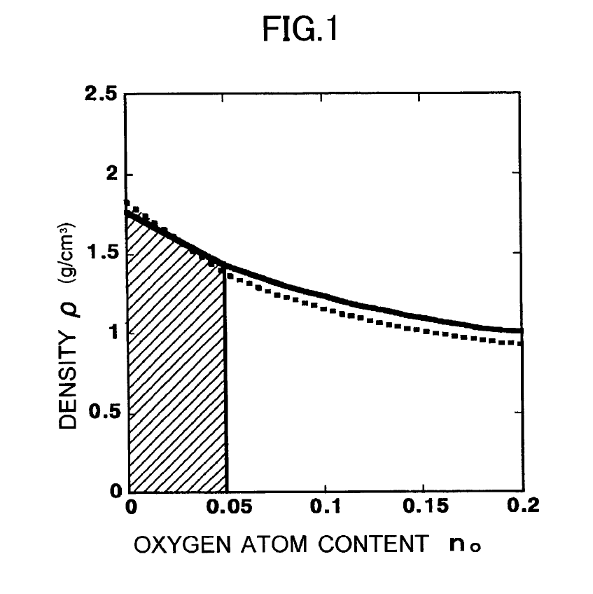

With respect to the polymer material, the relationship between the oxygen atom content nₒ and the density ρ is shown in FIG. 1.

Specifically, in the present invention, a polymer material corresponding to the shaded region shown in FIG. 1 is used in the resist material. In other words, in the polymer material, the atomic ratio of an oxygen atom to all atoms constituting the polymer material is relatively small, and hence the collective optical absorption of the polymer material can be lowered. Therefore, even when the resist layer has a thickness as large as 200 nm or more, the resist layer can achieve a transmittance as high as 40% or more, so that the resist layer exhibits resist properties. Further, the polymer material has an oxygen atom content nₒ of less than 0.05, and hence the resist layer can achieve high etching resistance.

Specifically, by using a polymer material having a density ρ and an oxygen atom content nₒ which fall in the shaded region shown in FIG. 1, a resist layer having a thickness as large as 200 nm and having a transmittance as high as 40% or more can be obtained. When using a polymer having a density ρ and an oxygen atom content nₒ which fall in the upper area of the shaded region, the resultant resist layer has a transmittance as low as less than 40%, so that a favorable rectangular resist pattern cannot be obtained. Further, when the resist layer has a thickness of less than 200 nm, the resist layer has a poor etching resistance, and thus a favorable pattern cannot be obtained after etching. On the other hand, when using a polymer material having a density ρ and an oxygen atom content no which fall in the right-hand area of the shaded region, namely, a polymer material having an increased oxygen atom content nₒ, the resultant resist layer has a poor etching resistance, and thus an favorable pattern cannot be obtained after etching.

Theoretical Introduction of Linear Absorption Coefficient

With respect to a polymer material, the optical absorption intensity in the wavelength range of an extreme ultraviolet (EUV) light is determined from the density of the polymer and the composition of the polymer in respect of the atoms contained in the polymer. In a polymer constituting a general resist material, the constituent atoms are comprised of three types of atoms, i.e., an oxygen atom, a carbon atom, and a hydrogen atom. Further, the polymer constituting a general resist material contains nₒ carbon-carbon triple bond. Specifically, in a general resist material, on an assumption that the polymer constituting the resist material does not contain a polycyclic aromatic ring larger than a benzene ring, the composition of the polymer in respect of an oxygen atom, carbon atom and hydrogen atom is represented by the following compositional formula: C₍₁₋ₙ₎ₘOₙH₁₋ₘ₊ₙ₍ₘ₋₁₎ wherein n and m satisfy, respectively, relationships: 0≦n≦1, and ⅓≦m≦½. When m is ⅓ in the above compositional formula, C:H is 1:2, that is, the polymer is an alkane containing an oxygen atom. On the other hand, when m is ½, C:H is 1:1, that is, the polymer is an alkene or benzene derivative containing an oxygen atom. In the hydrocarbon constituting a polymer for use in a resist material practically used, the constituent carbon atoms are not comprised solely of sp³ carbon or sp² carbon, but they are comprised of both sp³ carbon and sp² carbon. Therefore, with respect to the resist material practically used, m in the above compositional formula satisfies the relationship: ⅓≦m≦½.

The present inventor has theoretically introduced a linear absorption coefficient of a resist layer when changing the oxygen atom content nₒ and density ρ of the polymer material under the above-mentioned conditions, and, using the linear absorption coefficient introduced, a transmittance of the resist layer having a predetermined thickness is determined by making calculation. It is noted that the oxygen atom content nₒ used in the present invention is not in terms of the weight ratio but in terms of the atomic ratio of an oxygen atom to all atoms contained in the polymer material.

As an absorption coefficient per atom at a wavelength of 13 nm, the value described in Atomic Data and Nuclear Tables (Henke, B. L.; Gullikson, E. M.; Davis, J. C., 1993, 54, 181) is used.

With respect to polymethyl methacrylate (PMMA), it is known that the linear absorption coefficient at a wavelength of 13 nm determined from the above value and an experimental value of the density is very close to the experimental value of the linear absorption coefficient (see J. Vac. Sci. Technol. B (Kubaik, G. D.; Kneedler, E. M.; Hwang, R. Q.; Schulberg, M. T.; Berger, K. W.; Bjorkholm, J. E.; Mansfield, W. M., 1992, 10, 2593)). The results are shown in FIG. 1. In FIG. 1, a solid line curve corresponds to the polymer material having the above-shown compositional formula wherein n is ½, and a dotted line curve corresponds to the polymer material having the above-shown compositional formula wherein n is ⅓. When a polymer material comprised of an alkane and an alkene or a benzene derivative is used, a resist layer having a thickness as large as 200 nm and having a transmittance as high as 40% or more can be obtained as long as the density and oxygen atom content of the polymer material fall in the region under the curve shown in FIG. 1.

Embodiment

Hereinbelow, an embodiment to which the present invention is applied will be described with reference to the following illustrative examples and experimental results. An exposure experiment was conducted using, as a polymer material corresponding to the shaded region shown in FIG. 1, a polyhydroxystyrene resin based polymer material (density p: 1.211 g/cm³; oxygen atom content no: 0.0435) which is represented by formula (I) below. For comparison, another exposure experiment was conducted using, as a polymer material which does not correspond to the shaded region shown in FIG. 1, a novolak resin (density p: 1.135 g/cm³; oxygen atom content nₒ: 0.0588) represented by formula (II) below.

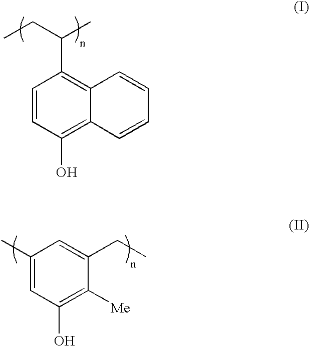

Using the above polymer materials, resist layers were individually prepared by a spin coating process. For the spin coating process, a spin coater which functions also as a developer (model: Mark 8; manufactured by TOKYO ELECTRON LIMITED, Japan) was used. Each resist layer prepared had a thickness of 205 nm.

With respect to each of the thus prepared resist films, an exposure experiment was conducted as follows.

First, the exposure apparatus used for exposure is briefly described below. The exposure apparatus can be roughly divided into four parts, i.e., a light source, an optical system, a mask placing and operating stage, and a wafer placing and operating stage. A radial light from an accumulation ring which is a light source part or an EUV light having a wavelength of 13 nm emitted from a plasma X-ray source reflects off a reflective mask having a reflective surface comprised of a molybdenum/silicon multilayer film, and then passes through a reflective optical system comprising several reflectors each having a reflective surface comprised of a molybdenum/silicon multilayer film, so that a mask pattern formed on the mask is transferred onto a wafer at a magnification of ⅕.

An EUV light has a wavelength as very short as 13 nm. Therefore, in the exposure apparatus, as a mask and an optical system, a conventional transmission mask and dioptric system are not used, but a reflective mask and a catoptric system are used wherein the reflective surface employed in each of them is comprised of a multilayer film prepared by alternately stacking on one another molybdenum and silicon each having a reflectance as very high as 68% at around 13 nm and each having a thickness of several nm so that the number of the molybdenum layers and that of the silicon layers are individually about 40.

The pattern on the reflective mask comprises an EUV light reflective surface comprised of a molybdenum/silicon multilayer film, and an EUV light absorbing surface comprised of an EUV light absorber, such as tantalum. When the EUV light entering the reflective mask, a light intensity difference is caused at the EUV light reflective surface and at the EUV light absorbing surface. The information of the light intensity difference passes through the catoptric system is reflected on the wafer, that is, the resist layer applied onto the wafer, and then a desired pattern is formed in the resist layer. For example, on the reflective mask, a line and space (L/S) in which the line width of tantalum 300 nm and the space width of the molybdenum/silicon multilayer film surface 300 nm is formed. The height of tantalum is 100 nm so as to secure a contrast between the tantalum and the EUV light reflective surface of 1,000 or more. Using this reflective mask, the pattern was transferred to a wafer onto which the above-described resist was applied. As a result, a line and space (L/S) of 60 nm was able to be formed in the resist at an exposure energy of about 50 nmJ/cm² although the resist had a thickness as large as 250 nm.

With respect to each of the thus exposed resist layers, the cross-section was examined under a scanning electron microscope (SEM) (model S4500, manufactured by Hitachi, Ltd., Japan), and results shown in Table 1 below were obtained. As is apparent from Table 1 below, when a polymer material corresponding to the shaded region shown in FIG. 1 was used in the resist layer, the condition of the resultant resist pattern was good, but, when a polymer material which does not correspond to the shaded region was used, the condition of the resultant resist pattern was bad.

TABLE 1

| Polymer | Pattern Condition |
|---|---|
| Formula (I) | Good |
| Formula (II) | Bad |

As mentioned above, it is found that by using a polymer material corresponding to the shaded region shown in FIG. 1, the transmittance of a resist layer having a thickness as large as 200 nm can be satisfactorily increased, making it possible to obtain a favorable resist pattern. That is, by using a polymer material corresponding to the shaded region shown in FIG. 1, a resist pattern more suitable for ultra-fine processing can be obtained.

In the above embodiment, an explanation is made taking as an example a polymer material comprised of a polyhydroxystyrene resin as a base, but the polymer material for use in a resist material or resist layer is not limited to this resin, and, for example, an acrylic polymer, a siloxane polymer, a silane polymer, a vinyl polymer, a polyimide polymer, and a fluorine polymer can be used as long as these polymers correspond to the shaded region shown in FIG. 1.

What is claimed is:

1. A resist material comprising a polymer material having an oxygen atom content nₒ of less than 0.05 in terms of the atomic ratio of an oxygen atom to all atoms contained in said polymer material, and having a density ρ which satisfies at least one formula selected from the group consisting of the following formulae (1) and (2):
$$\begin{matrix}ρ \leq \frac{\begin{matrix}3.66 \times ( 12.011 \times ( 1 - {n}_{o} ) / 2 + \\ 15.9994 \times {n}_{o} + 1.00794 \times ( 1 - {n}_{o} ) / 2 )\end{matrix}}{32.4297 \times ( 1 - {n}_{o} ) / 2 + 126.595 \times {n}_{o} + 1.3607 \times ( 1 - {n}_{o} ) / 2} \times 1.25 & ( 1 ) \\ ρ \leq \frac{\begin{matrix}3.66 \times ( 12.011 \times ( 1 - {n}_{o} ) / 3 + 15.9994 \times {n}_{o} + \\ 1.00794 \times ( 1 - {n}_{o} ) \times 2 / 3 )\end{matrix}}{\begin{matrix}32.4297 \times ( 1 - {n}_{o} ) / 3 + 126.595 \times \\ {n}_{o} + 1.3607 \times ( 1 - {n}_{o} ) \times 2 / 3\end{matrix}} \times 1.25 & ( 2 )\end{matrix}$$

2. The resist material according to claim 1, wherein said polymer material comprises at least one resin selected from the group consisting of a novolak resin, a polyhydroxystyrene resin, an acrylic resin, a siloxane resin having an ester group, a carboxyl group, or a phenolic hydroxyl group, a silsesquioxane resin, a polycycloolefin resin, a silane resin, a vinyl resin, a polyimide resin, and a fluorocarbon resin as a main skeleton.

3. The resist material according to claim 1, wherein said polymer material contains a group being capable of undergoing a chemical reaction due to light irradiation.

4. An exposure method comprising subjecting a resist layer to selective exposure to an X-ray and forming a predetermined pattern in the resist layer, wherein said resist layer comprises a polymer material having an oxygen atom content nₒ of less than 0.05 in terms of an atomic ratio of an oxygen atom to all atoms contained in said polymer material, and having a density ρ which satisfies at least one formula selected from the group consisting of the following formulae (1) and (2):
$$\begin{matrix}ρ \leq \frac{\begin{matrix}3.66 \times ( 12.011 \times ( 1 - {n}_{o} ) / 2 + \\ 15.9994 \times {n}_{o} + 1.00794 \times ( 1 - {n}_{o} ) / 2 )\end{matrix}}{32.4297 \times ( 1 - {n}_{o} ) / 2 + 126.595 \times {n}_{o} + 1.3607 \times ( 1 - {n}_{o} ) / 2} \times 1.25 & ( 1 ) \\ ρ \leq \frac{\begin{matrix}3.66 \times ( 12.011 \times ( 1 - {n}_{o} ) / 3 + 15.9994 \times {n}_{o} + \\ 1.00794 \times ( 1 - {n}_{o} ) \times 2 / 3 )\end{matrix}}{\begin{matrix}32.4297 \times ( 1 - {n}_{o} ) / 3 + 126.595 \times \\ {n}_{o} + 1.3607 \times ( 1 - {n}_{o} ) \times 2 / 3\end{matrix}} \times 1.25 & ( 2 )\end{matrix}$$

5. The exposure method according to claim 4, wherein said polymer material comprises at least one resin selected from the group consisting of a novolak resin, a polyhydroxystyrene resin, an acrylic resin, a siloxane resin having an ester group, a carboxyl group, or a phenolic hydroxyl group, a silsesquioxane resin, a polycycloolefin resin, a silane resin, a vinyl resin, a polyimide resin, and a fluorocarbon resin as a main skeleton.

6. The exposure method according to claim 4, wherein said polymer material contains a group being capable of undergoing a chemical reaction due to light irradiation.

7. The exposure method according to claim 4, wherein said resist layer has a thickness of 200 nm or more.

8. The exposure method according to claim 4, wherein an extreme ultraviolet light is used as said X-ray.

9. The exposure method according to claim 8, wherein said extreme ultraviolet light has a wavelength of 7 to 16 nm.

10. The exposure method according to claim 4, wherein said exposure is conducted by reduction projection utilizing a reduction projection optical system.
